(19) United States
(12) Patent Application Publication
(10) Pub. No.: US 2024/0341315 A1
(43) Pub. Date: Oct. 17, 2024

(54) Fish Scaler Pocket Knife Device

(71) Applicants: Mandy Logan, Rutherfordton, NC (US); Lewis Aaron Logan, Rutherfordton, NC (US)

(72) Inventors: Mandy Logan, Rutherfordton, NC (US); Lewis Aaron Logan, Rutherfordton, NC (US)

(21) Appl. No.: 18/398,477

(22) Filed: Dec. 28, 2023

Related U.S. Application Data
(60) Provisional application No. 63/495,334, filed on Apr. 11, 2023.

(51) Int. Cl. A22C 25/17; A22C 25/00

(52) U.S. Cl. CPC A22C 25/17; A22C 25/006

(57) ABSTRACT

A fish scaler pocket knife device is provided. The device is comprised of two body ends, each serving a different purpose with the benefit of one device. The device is comprised of a fish cleaning tool on one end. Additionally, the device is comprised of a fish descaling tool on the opposite end. The body ends are attached at a point of rotation. The knife can be rotated degrees to store safely in the recessed area of the descaling tool.

### CROSS-REFERENCE TO RELATED APPLICATION

The present application claims priority to, and the benefit of, U.S. Provisional Application No. 63/495,334, which was filed on Apr. 11, 2023, and is incorporated herein by reference in its entirety.

### FIELD OF THE INVENTION

The present invention relates generally to the field of knives. More specifically, the present invention relates to a fish scaler pocket knife device designed to allow a user to descale and gut a fish using the same tool. Accordingly, the present disclosure makes specific reference thereto. Nonetheless, it is to be appreciated that aspects of the present invention are also equally applicable to other like applications, devices, and methods of manufacture.

### BACKGROUND

Generally, individuals require multiple tools to descale and gut a fish. When using multiple tools, individuals may become frustrated with constantly swapping back and forth from one tool to another. Fishing knives and scalers are sharp utensils that can cause accidental injury when individuals are working quickly and lack the attention required when using sharp tools. Additionally, the inconvenience of multiple tools increases the risk of dropping and losing the tools while individuals clean and scale the fish outdoors.

With the increased number of individuals that fish for recreation, competitive pay, or as a sport, the development of new versatile fish scalers and gutting tools are needed. While professional anglers are in need of a tool that is efficient, easy to use, and convenient, novice fishers additionally prefer a single tool to meet the needs of cleaning a fish. Generally, individuals exploring new sports are reluctant to purchase all the necessary equipment before determining if their interest is high enough to make the financial investment, therefore, developing one tool that has multiple uses is attractive to many people.

Therefore, there exists a long-felt need in the art for a device that improves the process of removing scales and gutting a fish. More specifically, there exists a long-felt need in the art for a fish scaler pocket knife device that can serve as both a fish scaler and a cutting tool in a single device. Additionally, there exists a long-felt need in the art for a knife tool that is convenient and simple to use when cleaning and removing scales from a fish. Furthermore, there exists a long-felt need in the art for a pocket knife that expedites the scaling and gutting process while enhancing safety and preventing accidents. Finally, there exists a long-felt need in the art for a device that attaches easily to a backpack, buckle, or other fishing equipment that reduces the chances of individuals losing a tool, more specifically while outdoors.

The subject matter disclosed and claimed herein, in one embodiment thereof, comprises a fish scaler pocket knife device. The device is designed to scale and clean a fish with the use of one tool. The device is comprised of a base component that has two ends attached at a rotation point. The device has a grip area that has a textured surface or is made with plastic, rubber, or other suitable material to prevent slipping when in use. The first body end of the device is a knife or blade for cleaning and cutting fish. The second body end of the device serves to scale or remove the skin of a fish. The device provides a compact, easy-to-use, and carry improved fish scaler pocket knife in one tool.

In this manner, the fish scaler pocket knife device of the present invention accomplishes all the forgoing objectives and provides a device that improves the process of removing scales and gutting a fish. More specifically, the fish scaler pocket knife device eliminates the frustration of having multiple tools and the risk of losing them when outdoors. Furthermore, the device can be designed to be used on a variety of fish and additional safety features to increase the desirability to amateur or professional anglers.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fish scaler pocket knife device comprised of a first end body and a second end body that is attached at a point of rotation. The device is designed to clean and descale fish with the use of one device. Individuals will no longer need multiple tools when cleaning a fish, therefore expediting the fish-cleaning process with the added convenience of a compact and easy-to-use device.

The device is comprised of a first body end and a second body end made from a steel or metal material that is rust-proof and durable enough to withstand the demands of cleaning and gutting fish. The first end body is a comprised of a sharp knife or blade with at least one sharp edge. The blade may be serrated, filleted, boning, gut hook, cleaver, spear, butcher, or other suitable blade type, depending on the type of fish being cleaned. The knife serves as the gutting or cleaning tool for fish. Its simplistic design and case of use makes the device desirable for professional anglers or the amateur fisher.

The knife is attached to the second body end at a point of rotation and can rotate 180 degrees for compact easy storage. The second body end has a flat base with two raised sides that have a least one tooth. The top is open so that the knife or blade can rest in the recessed area of the second body end when not in use. As a result, the blade is safely and securely positioned lying flat in the recessed area to avoid accidental injury. The second body end is made from a strong durable steel material that is rustproof and can be forged with at least one sharp tooth on the outer edges for effectively descaling a fish.

The present invention in one embodiment has a point of rotation that connects the first body and the second body end. The point of rotation allows the device to open and close with ease for convenience and safety. When the device is closed at the point of rotation, it is in a compact state and is safe to carry, store, or attach to other fishing apparatus.

The present invention in one embodiment has a snap latch, lock, or other fastener to prevent the fish scaler pocket knife from accidentally opening. The added safety feature enhances the safety of the device. The fastener may have a loop or other opening to hang or store the device in a manner that can be quickly and easily grabbed for convenience. Generally, the fastener will prevent the knife or blade from unintentionally extending and causing a serious accidental injury.

The present invention in one embodiment has a clasp, clip, hook, or other suitable fastener to attach the device to an individual's belt loop, backpack, or other suitable equipment in the art. Generally, outdoor water or recreational sports require multiple pieces of equipment to fully participate. Typically, individuals participating in these outdoor water activities prefer to limit the equipment to as few pieces as possible for convenience and ease of transporting the tools.

Accordingly, the fish scaler pocket knife device of the present invention is particularly advantageous as it provides individuals with a tool that has multiple uses when cleaning fish. More specifically, it eliminates the need for individuals to carry multiple tools or swap between multiple tools when cleaning fish. Additionally, the device can be used by professional anglers and individuals who fish for recreation or as a hobby. Furthermore, the device increases the efficiency with which fish are cleaned while increasing safety for the user with a non-slip grip area and recessed area for storing the knife. In this manner, the fish scaler pocket knife device overcomes the limitations of existing fish scaling devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of a fish scaler pocket knife device of the present invention in accordance with the disclosed architecture;

FIG. 2 illustrates a bottom view of one potential embodiment of a fish scaler pocket knife device of the present invention in accordance with the disclosed architecture; and

FIG. 3 illustrates a flowchart of a method of using one potential embodiment of a fish scaler pocket knife device of the present invention in accordance with the disclosed architecture.

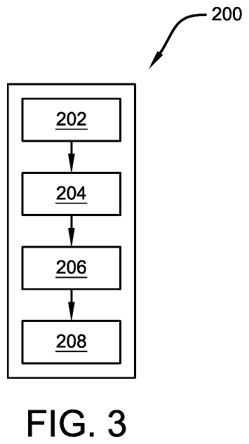

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that improves the process of removing scales and gutting a fish. More specifically, there exists a long-felt need in the art for a fish scaler pocket knife device that can serve as a fish scaler and knife with one tool. Additionally, there exists a long-felt need in the art for a knife tool that is convenient and simple to use when cleaning and removing scales from a fish. Furthermore, there exists a long-felt need in the art for a pocket knife that expedites the scaling and gutting process without the need for multiple tools. Finally, there exists a long-felt need in the art for a device the reduces the chances of individuals losing a tool while outdoors and increases the safety of users and reduces the risk of accidental injury.

The present invention, in one exemplary embodiment, is comprised of a fish scaler pocket knife device. The device provides users with one tool that serves as a knife to gut fish and a scaler to remove the skin from fish. The device is comprised of a body with a grip that is textured, raised, or surrounded by a rubber or plastic material for a non-slip grip. Additionally, a recessed area to store the blade when the device is in a closed position. The device is preferably made from a rubber, metal, or other plastic material, a combination of the previous suitable in the art. The non-slip grip reduces the risk of injury to individuals using the device, especially with wet or slippery hands after handling a fish.

More specifically, the device is comprised of a first body end and a second body end with a rotation point. The knife blade design may vary depending on the user's preference. Specifically, the knife blade may be serrated, filleting, boning, gut hook, cleaver, spear, butcher, or other appropriate blade type. The first end body knife may be constructed of carbon steel, stainless steel, tool steel, alloy steel, or other suitable material in the art of knives. Additionally, the material of the knife may be made from a steel or metal that is rust-proof and durable to withstand the demands of cleaning and gutting fish. Generally, blade types may vary among professional anglers and amateur users of the device.

Additionally, the fish scaler pocket knife device is comprised of a second body end that serves as a fish scaling tool. The second body end has a base flat surface with two raised sides. The two raised sides have a least one tooth on the edge to scale the fish. In one embodiment, the second body end has two openings. In one embodiment, these openings serve as a window to allow individuals to see the level of scaling needed. The openings may also have at least one tooth to expedite the process of scaling fish and serve as an exit window for the removed scales. Finally, the outer flat surface of the second end body has a grip area to avoid slipping when using the tool. Typically, the grip area is designed with a non-slip surface in mind. The grip area may include a raised or textured surface for a more secure grip or be coated with a rubber, metal, plastic, or other non-slip material to provide additional safety measures while individuals are using the device.

Furthermore, the recessed area with the two raised sides of the second body end prevents the fish scales from spraying the removed scales and creating a mess while raking the scaling tool along the fish. The teeth on the scaler are sharp and durable to expedite the process with ease. Generally, gutting and scaling fish can become quite messy, and the recessed area promotes less mess when cleaning fish.

The present invention in one embodiment has a point of rotation that connects the first end body and the second end body. The point of rotation allows the device to open and close with case for convenience and safety. The point of rotation can be made with a screw, pin, roller, or other suitable attachment. Finally, the rotation point and compact size of the device makes it easy to store the blade when not in use and fits easily into a pocket.

The present invention in one embodiment has a snap, latch, lock, or other fastener to prevent the fish scaler pocket knife from accidentally opening. The snap, latch, lock, or fastener made be made from metal, plastic, rubber, or other suitable material. The added safety feature enhances the protection of accidental injury from the device. When not in use, the bends easily into a contracted state and rests in the recessed area of the second body end. The recessed area prevents the sharp edge of the knife from being exposed when stored or not in use. Generally, the fastener will prevent the knife or blade from unintentionally extending and causing an accidental injury.

During use, the first body end and the second body end rotate 180 degrees to an open state. The second body end component is used as the handle to grip when individuals use the knife to cut and clean fish. More specifically, the recessed edges have at least one tooth to scale fish with case. As individuals are raking the skin of the fish, the device easily removes the scales from the fish. After cleaning the fish, individuals will bend the knife or blade into the second body end at the point of rotation and lock the device with the latch or clasp. Generally, the clasp or latch prevents the device from opening unintentionally and causing injury.

The present invention is also comprised of a method of using the device. First, a device is provided comprised of a first body end, where a knife is attached at a rotating point to a second body end composed of at least one tooth. Then, the knife is folded from the body and the device is used to cut and clean various types of fish. Then, the knife is folded back into the second body end at the point of rotation. Once the knife is secure in the second body end of the device, the descaling portion with the teeth may be used to remove the skin from the fish.

Accordingly, the fish scaler knife pocket device of the present invention is particularly advantageous as it provides a device that eliminates the need for more than one tool when gutting and scaling a fish. More specifically, combining these devices will expedite the fish scaling process and allow users to be more organized and efficient. Furthermore, the recessed area provides enhanced safety to prevent accidents when not in use.

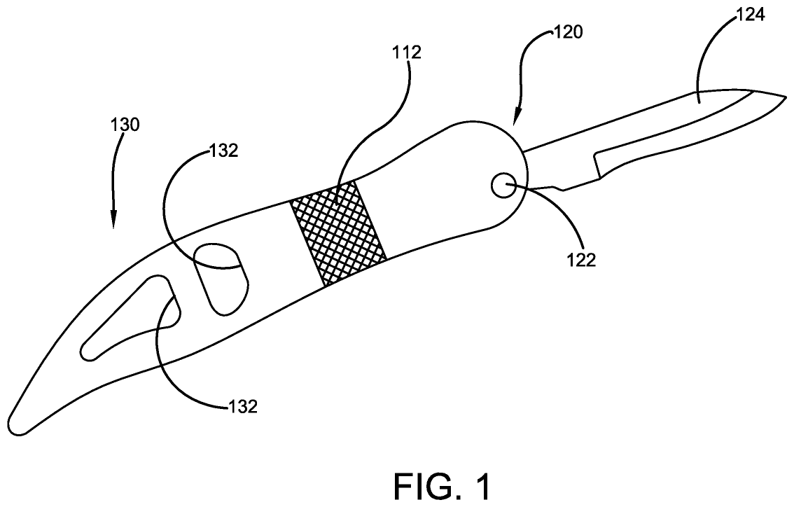

Referring initially to the drawings, FIG. 1 illustrates a top view of one potential embodiment of a fish scaler pocket knife device 100 of the present invention in accordance with the disclosed architecture. The device 100 comprised of a body 110 having a first body end 120 and a second body end 130. The device 100 is designed to allow a user to gut and scale fish while only using a singular tool.

The first body end 120 is preferably made from a rust-proof steel or metal material. The first end 120 is comprised of at least one knife blade 124. The knife blade 124 may be any style of blade such as but not limited to serrated, filleted, boning, gut hook, cleaver, spear, butcher, or other suitable blade type. The knife 124 is used for gutting and cleaning a fish.

The second body end 130 is comprised of at least one tooth 134 and at least one, but preferably two, openings 132. The two openings 132 serve as windows to determine the level scaling needed and an exit for the removed skin. The body part 110 may have a textured or raised grip area 112 to provide a non-slip safety feature. Said grip area 112 may be comprised of a raised or recessed texture. The grip area 112 may be made from any material known in the art, including the same material as the body 110 and/or a non-slip material such as but not limited to rubber. As a result, the grip area 112 decreases the risk of accidental injury.

In one embodiment, the device 100 is comprised of at least one rotation point 122 that allows the knife 124 of the first body end 120 to rotate and be stored within at least one recessed area 114 of the second body end 130. The knife 124 may rotate 360 degrees around the pivot point 122. In one embodiment, the pivot point 122 is comprised of a locking pivot point that locks the knife 124 in a fixed position.

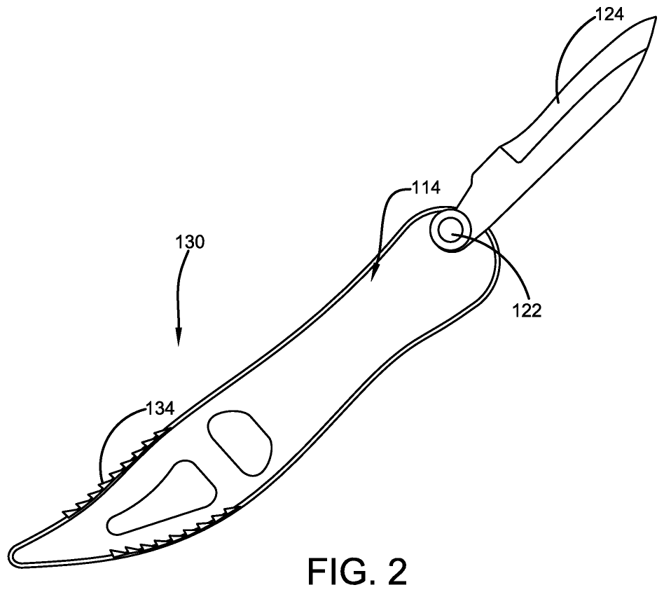

FIG. 2 illustrates a bottom view of one potential embodiment of a fish scaler pocket knife device 100 of the present invention in accordance with the disclosed architecture. The device 100 is comprised of a recessed area 114. The recessed area 114 serves as an area to safely store the knife 124 when not in use. Securing the knife 124 in the recessed area 114 of the device 100 reduces the risk of accidental injuries.

During use of the device 100, at least one tooth 134 is used to remove scales from fish with case and efficiency. The device 100 allows for users to transition from cleaning fish with the knife 124 to scaling fish with the sharp teeth 134 smoothly without slowing the process. Additionally, the two openings 132, may have at least one tooth 134 to remove scales and serve as a window to determine the level of descaling needed.

The present invention is also comprised of a method of using 200 the device 100. First, a device 100 is provided comprised of a body 110 comprised of at least one knife blade 124 attached to the first end 120 of the body 110 via at least one rotation point 122, and a second body end 130 comprised of at least one tooth 134 [Step 202]. Then, the knife 124 can be folded out from the second body at the rotation point and used to cut a fish [Step 204]. Then, the knife 124 can be folded back into at least one recessed area 114 of the body 110 [Step 206]. Then, the teeth 134 can be used to descale a fish [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fish scaler pocket knife device” and “device” are interchangeable and refer to the fish scaler pocket knife device 100 of the present invention.

Notwithstanding the forgoing, the fish scaler pocket knife device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fish scaler pocket knife device 100 as shown in the FIGS. are for illustrative purposes only, and that many other sizes and shapes of the fish scaler pocket knife device 100 are well within the scope of the present disclosure. Although the dimensions of the fish scaler pocket knife device 100 are important design parameters for user convenience, the fish scaler pocket knife device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fish scaler pocket knife device comprising:
a body comprised of a first end and a second end;
a knife blade positioned on the first end; and
a tooth positioned on the second end.

2. The fish scaler pocket knife device of claim 1, wherein the body is comprised of an opening.

3. The fish scaler pocket knife device of claim 1, wherein the knife blade is comprised of a serrated blade, a fillet blade, a boning blade, a gut hook blade, a cleaver blade, a spear blade, or a butcher blade.

4. The fish scaler pocket knife device of claim 1, wherein the knife blade attaches to the first end via a rotation point.

5. The fish scaler pocket knife device of claim 4, wherein the rotation point is comprised of a locking rotation point.

6. The fish scaler pocket knife device of claim 1, wherein the body is comprised of a recessed area.

7. A fish scaler pocket knife device comprising:
a body comprised of a grip area, a first end, and a second end;
a knife blade positioned on the first end; and
a tooth positioned on the second end.

8. The fish scaler pocket knife device of claim 7, wherein the body is comprised of an opening.

9. The fish scaler pocket knife device of claim 7, wherein the knife blade is comprised of a serrated blade, a fillet blade, a boning blade, a gut hook blade, a cleaver blade, a spear blade, or a butcher blade.

10. The fish scaler pocket knife device of claim 7, wherein the knife blade attaches to the first end via a rotation point.

11. The fish scaler pocket knife device of claim 10, wherein the rotation point is comprised of a locking rotation point.

12. The fish scaler pocket knife device of claim 7, wherein the body is comprised of a recessed area.

13. The fish scaler pocket knife device of claim 7, wherein the grip area is comprised of a raised texture or a recessed texture.

14. The fish scaler pocket knife device of claim 7, wherein the grip area is comprised of a non-slip rubber material.

15. A method of using a fish scaler pocket knife device, the method comprising the following steps:
providing a fish scaler pocket knife device comprised of a body comprised of a knife blade attached to a first body end via rotation point, and a second body end comprised of a tooth;
using the knife to cut a fish;
folding the knife into a recessed area of the body; and
using the tooth to descale the fish.

16. The method of using a fish scaler pocket knife device of claim 15, wherein the rotation point is comprised of a locking rotation point.

17. The method of using a fish scaler pocket knife device of claim 15, wherein the knife blade is comprised of a serrated blade, a fillet blade, a boning blade, a gut hook blade, a cleaver blade, a spear blade, or a butcher blade.

18. The method of using a fish scaler pocket knife device of claim 15, wherein the body is comprised of a grip area.

19. The fish scaler pocket knife device of claim 18, wherein the grip area is comprised of a raised texture or a recessed texture.

20. The fish scaler pocket knife device of claim 15, wherein the body is comprised of an opening.
